(19) United States
(12) Patent Application Publication
(10) Pub. No.: US 2018/0061395 A1
(43) Pub. Date: Mar. 1, 2018

(54) APPARATUS AND METHOD FOR TRAINING A NEURAL NETWORK AUXILIARY MODEL, SPEECH RECOGNITION APPARATUS AND METHOD

(71) Applicant: Kabushiki Kaisha Toshiba, Minato-ku (JP)

(72) Inventors: Pei DING, Beijing (CN); Kun YONG, Beijing (CN); Yong HE, Beijing (CN); Huifeng ZHU, Beijing (CN); Jie HAO, Beijing (CN)

(73) Assignee: Kabushiki Kaisha Toshiba, Minato-ku (JP)

(21) Appl. No.: 15/339,071

(22) Filed: Oct. 31, 2016

(30) Foreign Application Priority Data
Aug. 31, 2016 (CN) 201610798027.9

(51) Int. Cl. G10L 15/06; G10L 15/16; G10L 15/183; G06N 3/08; G06N 3/04

(52) U.S. Cl. CPC G10L 15/063; G10L 15/16; G06N 3/04; G06N 3/08; G10L 15/183

(57) ABSTRACT

According to one embodiment, an apparatus trains a neural network auxiliary model used to calculate a normalization factor of a neural network language model. The apparatus includes a calculating unit and a training unit. The calculating unit calculates a vector of at least one hidden layer and a normalization factor by using the neural network language model and a training corpus. The training unit trains the neural network auxiliary model by using the vector of the at least one hidden layer and the normalization factor as an input and an output respectively.

### CROSS-REFERENCE TO RELATED APPLICATION

This application is based upon and claims the benefit of priority from Chinese Patent Application No. 201610798027.9, filed on Aug. 31, 2016; the entire contents of which are incorporated herein by reference.

### FIELD

Embodiments relate to an apparatus and a method for training a neural network auxiliary model, a speech recognition apparatus and a speech recognition method.

### BACKGROUND

A speech recognition system commonly includes an acoustic model (AM) and a language model (LM). The acoustic model is used to represent the relationship between acoustic feature and phoneme units, while the language model is a probability distribution over sequences of words (word context), and speech recognition process is to obtain result with the highest score from weighted sum of probability scores of the two models.

In recent years, neural network language model (NN LM), as a novel method, has been introduced into speech recognition systems and greatly improves the speech recognition performance.

Compared to the traditional language model, the neural network language model can improve the accuracy of speech recognition. But due to the high calculation cost, it is hard to meet the practical use. The main reason is that, for the neural network language model, it must ensure the sum of all the target output probabilities is equal to one and it is implemented by a normalization factor. The way to calculate the normalization factor is to calculate a value of each output target and then the sum of all the values, so the computation cost depends on the number of the output target. For the neural network language model, it is determined by a size of the vocabulary. Generally speaking, the size can up to be tens or even hundreds of thousands, which causes that the technology cannot be applied to real-time speech recognition system.

In order to solve the computational problem of the normalization factor, traditionally, there are two methods.

One approach is to modify the training objective. The traditional objective is to improve the classification accuracy of the model, the new added objective is to reduce the variation of the normalization factor, and the normalization factor is set to be constant approximately. During the training, there is a parameter to tune the weight of the two training objectives. In practical application, there is no need to calculate the normalization factor and it can be replaced with the approximate constant.

The other approach is to modify the structure of the model. The traditional model is to do the normalization based on all the words. The new model is to classify all words into classes in advance, and the probability of the output words is calculated by multiplying probability of the class to which the word belongs with the probability of the word within the class. For the probability of a word within the class, it just needs to sum output values of the words in the same class rather than all the words in the vocabulary, which will speed up the calculation of the normalization factor.

Although the above methods for solving the problem of the normalization factor in the traditional neural network language model decrease the computation, the decrease of the computation is realized by sacrificing the classification accuracy. Moreover, the weight of the training objectives involved in the above first method must be tuned by practical experience, which increases complexity of the model.

### BRIEF DESCRIPTION OF THE DRAWINGS

FIG. 1 is a flowchart of a method for training a neural network auxiliary model according to a first embodiment.

FIG. 2 is a flowchart of an example of the process of training a neural network auxiliary model according to the first embodiment.

FIG. 3 is a flowchart of a speech recognition method according to a second embodiment.

FIG. 4 is a flowchart of an example of the speech recognition method according to the second embodiment.

FIG. 5 is a block diagram of an apparatus for training a neural network auxiliary model according to a third embodiment.

FIG. 6 is a block diagram of a speech recognition apparatus according to a fourth embodiment.

FIG. 7 is a block diagram of an example of the speech recognition apparatus according to the fourth embodiment.

### DETAILED DESCRIPTION

According to one embodiment, an apparatus trains a neural network auxiliary model used to calculate a normalization factor of a neural network language model. The apparatus includes a calculating unit and a training unit. The calculating unit calculates a vector of at least one hidden layer and a normalization factor by using the neural network language model and a training corpus. The training unit trains the neural network auxiliary model by using the vector of the at least one hidden layer and the normalization factor as an input and an output respectively.

Below, preferred embodiments will be described in detail with reference to drawings.

### <A Method for Training a Neural Network Auxiliary Model>

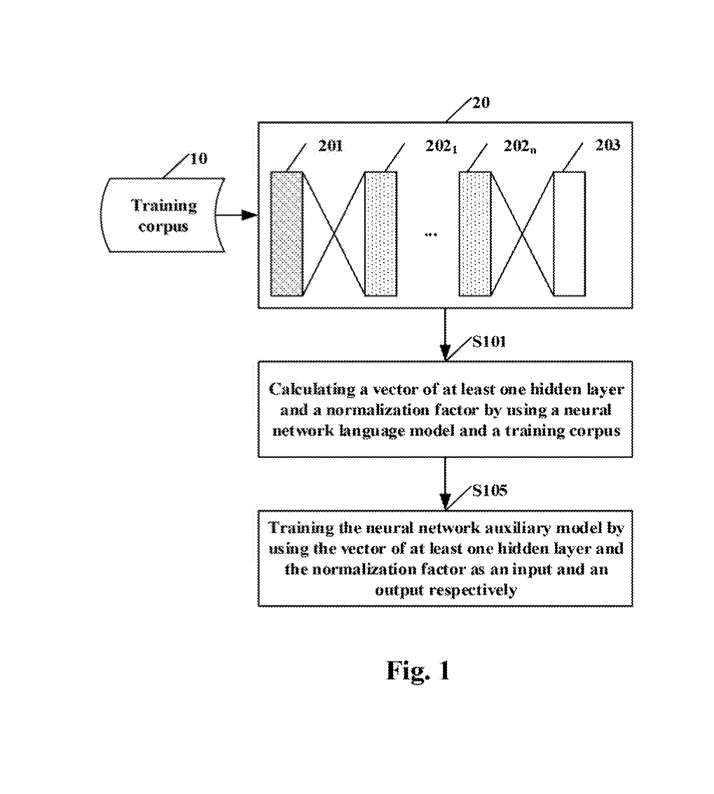

FIG. 1 is a flowchart of a method for training a neural network auxiliary model according to the first embodiment. The neural network auxiliary model of the first embodiment is used to calculate a normalization factor of a neural network language model, and the method for training the neural network auxiliary model of the first embodiment comprises: calculating a vector of at least one hidden layer and a normalization factor by using the neural network language model and a training corpus; and training the neural network auxiliary model by using the vector of at least one hidden layer and the normalization factor as an input and an output respectively.

As shown in FIG. 1, first, in step S101, a vector of at least one hidden layer and a normalization factor are calculated by using a neural network language model 20 trained in advance and a training corpus 10.

The neural network language model 20 includes an input layer 201, hidden layers 202₁, . . . , 202ₙ and an output layer 203.

In the first embodiment, preferably, at least one hidden layer is the last hidden layer 202n. At least one hidden layer can also be a plurality of layers, for example, including the last hidden layer 202ₙ and the last second hidden layer 202ₙ₋₁, and the first embodiment has no limitation on this. It can be understood that the more the layers are, the higher the accuracy of the normalization factor is, meanwhile the bigger the computation is.

In the first embodiment, preferably, the vector of at least one hidden layer is calculated through forward propagation by using the neural network language model 20 and the training corpus 10.

Next, in step S106, the neural network auxiliary model is trained by using the vector of at least one hidden layer and the normalization factor calculated in step S101 as an input and an output respectively. Actually, the neural network auxiliary model can be considered as a function to fit the vector of at least one hidden layer and the normalization factor. There are various models which can be used as the auxiliary model to estimate the normalization factor. The more parameters the model has, the more accurate the estimation of the normalization is, and meanwhile it requires much higher computation cost. In practical application, according to the requirement, different sizes of models can be chosen to balance the accuracy and calculation speed.

In the first embodiment, preferably, the neural network auxiliary model is trained by using the vector of at least one hidden layer as the input and using a logarithm of the normalization factor as the output. In the first embodiment, in the case that the differences of the normalization factor in the train corpus are large, a logarithm of the normalization factor is used as the output.

In the first embodiment, preferably, the neural network auxiliary model is trained by decreasing an error between a prediction value and a real value of a normalization factor, wherein the real value is the calculated normalization factor. Moreover, preferably, the error is decreased by updating parameters of the neural network auxiliary model by using a gradient decent method. Moreover, preferably, the error is a root mean square error.

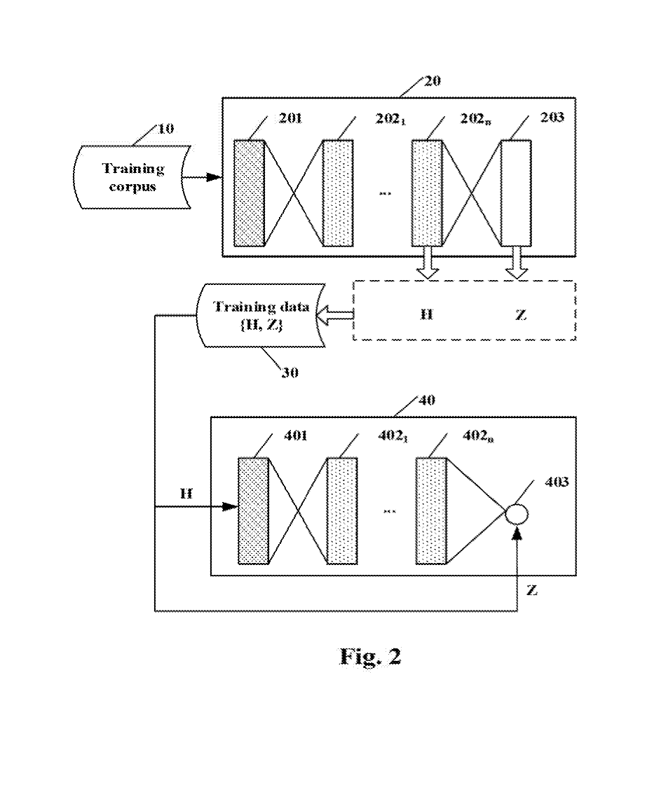

Next, an example will be described in details with reference to FIG. 2. FIG. 2 is a flowchart of an example of the process of training a neural network auxiliary model according to the first embodiment.

As shown in FIG. 2, the normalization factor Z is calculated by the neural network language model 20 by using the training corpus 10, the vector H of the last hidden layer 202ₙ is calculated through forward propagation, and the training data 30 is obtained.

Then, the neural network auxiliary model 40 is trained by using the vector H of the last hidden layer 202ₙ as the input of the neural network auxiliary model 40 and using the normalization factor Z as the output of the neural network auxiliary model 40. The training objective is to decrease a root mean square error between a prediction value and a real value which is the normalization factor Z. The root mean square error is decreased by updating parameters of the neural network auxiliary model by using a gradient decent method until the model is converged.

The method for training a neural network auxiliary model of the first embodiment uses an auxiliary model to fit the normalization factor and do not involve an extra parameter like the weight of the training objectives which must be tuned by practical experience compared to the traditional method which uses new training objective function. Therefore, the whole training is much more simple and easy to use, and the computation is decreased while the classification accuracy is not decreased.

<A Speech Recognition Method>

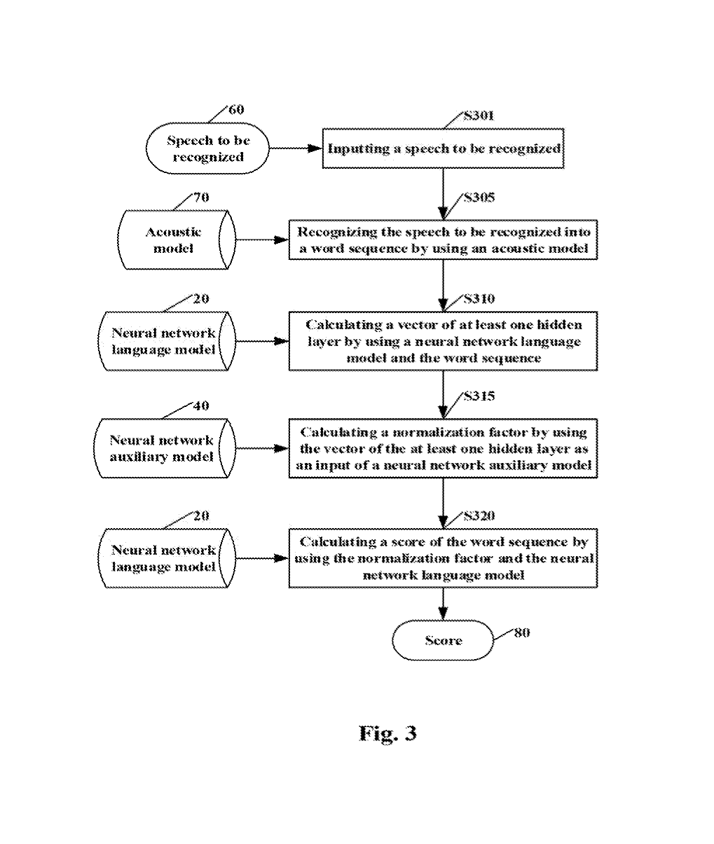

FIG. 3 is a flowchart of a speech recognition method according to a second embodiment under a same inventive concept. Next, this embodiment will be described in conjunction with that figure. For those same parts as the above embodiments, the description of which will be properly omitted.

The speech recognition method for the second embodiment comprises: inputting a speech to be recognized; recognizing the speech to be recognized into a word sequence by using an acoustic model; calculating a vector of at least one hidden layer by using a neural network language model and the word sequence; calculating a normalization factor by using the vector of the at least one hidden layer as an input of a neural network auxiliary model trained by using the method of the first embodiment; and calculating a score of the word sequence by using the normalization factor and the neural network language model.

As shown in FIG. 3, in step S301, a speech to be recognized 60 is inputted. The speech to be recognized may be any speech and the embodiment has no limitation thereto.

Next, in step S305, the speech to be recognized 60 is recognized into a word sequence by using an acoustic model 70.

In the second embodiment, the acoustic model 70 may be any acoustic model known in the art, which may be a neural network acoustic model or may be other type of acoustic model.

In the second embodiment, the method for recognizing a speech to be recognized 60 into a word sequence by using the acoustic model 70 is any method known in the art, which will not be described herein for brevity.

Next, in step S310, a vector of at least one hidden layer is calculated by using a neural network language model 20 trained in advance and the word sequence recognized in step S305.

In the second embodiment, the vector of which layer or which layers is calculated is determined based on an input of a neural network auxiliary model 40 trained by using the method for the first embodiment. Preferably, the vector of the last hidden layer is used as the input when training the neural network auxiliary model 40, and, in this case, in step S310, the vector of the last hidden layer is calculated.

Next, in step S315, a normalization factor is calculated by using the vector of at least one hidden layer calculated in step S310 as the input of the neural network auxiliary model 40.

Last, in step S320, a score of the word sequence is calculated by using the normalization factor calculated in step S315 and the neural network language model 20.

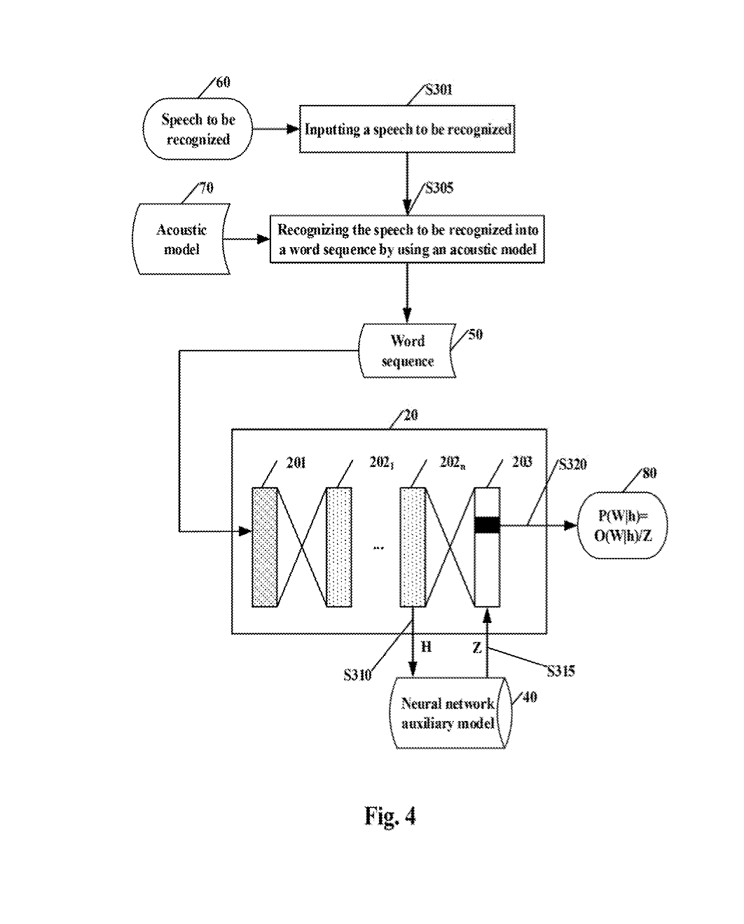

Next, an example will be described in details with reference to FIG. 4. FIG. 4 is a flowchart of an example of the speech recognition method according to the second embodiment.

As shown in FIG. 4, in step S305, the speech to be recognized 60 is recognized into a word sequence 60 by using an acoustic model 70.

Then, the word sequence 50 is inputted into the neural network language model 20, and the vector H of the last hidden layer 202ₙ is calculated through forward propagation.

Then, the vector H of the last hidden layer 202ₙ is inputted into the neural network auxiliary model 40, and the normalization factor Z is calculated.

Then, the normalization factor Z is inputted into the neural network language model 20, and the score of the word sequence 50 is calculated by using the following formula based on the output “O(W|h)” 80 of the neural network language model 20.

P(W|h)=O(W|h)/Z

The speech recognition method of the second embodiment uses a neural network auxiliary model trained in advance to calculate the normalization factor of the neural network language model. Therefore, the computation speed of the neural network language model can be significantly increased, and the speech recognition method can be applied to the real-time speech recognition system.

<An Apparatus for Training a Neural Network Auxiliary Model>

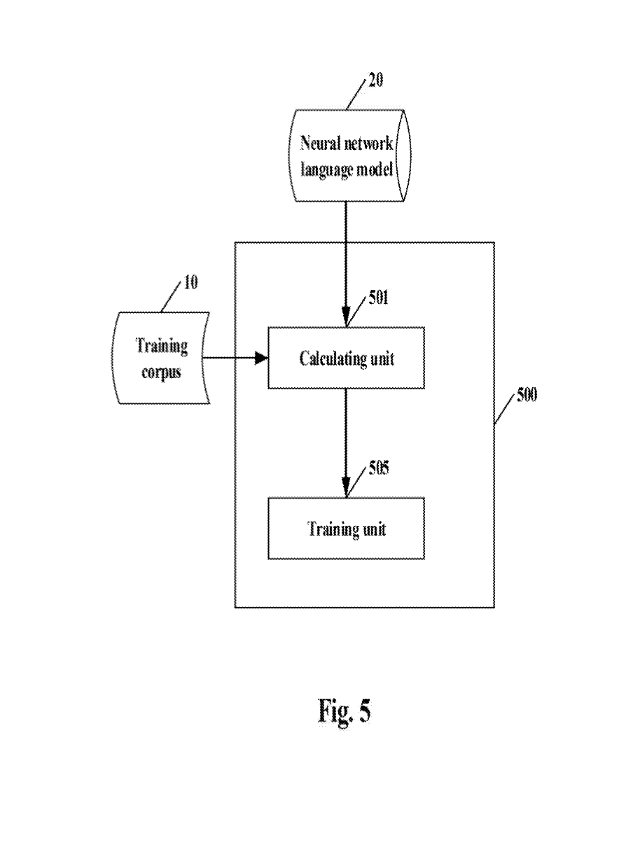

FIG. 5 is a block diagram of an apparatus for training a neural network auxiliary model according to a third embodiment under a same inventive concept. Next, this embodiment will be described in conjunction with that figure. For those same parts as the above embodiments, the description of which will be properly omitted.

The neural network auxiliary model of the third embodiment is used to calculate a normalization factor of a neural network language model. As shown in FIG. 5, the apparatus 500 for training a neural network auxiliary model comprises: a calculating unit 501 that calculates a vector of at least one hidden layer and a normalization factor by using the neural network language model 20 and a training corpus 10; and a training unit 505 that trains the neural network auxiliary model by using the vector of at least one hidden layer and the normalization factor as an input and an output respectively.

In the third embodiment, as shown in FIG. 1, the neural network language model 20 includes an input layer 201, hidden layers 202₁, . . . , 202ₙ and an output layer 203.

In the third embodiment, preferably, at least one hidden layer is the last hidden layer 202ₙ. At least one hidden layer can also be a plurality of layers, for example, including the last hidden layer 202ₙ and the last second hidden layer 202ₙ₋₁, and the third embodiment has no limitation on this. It can be understood that the more the layers are, the higher the accuracy of the normalization factor is, meanwhile the bigger the computation is.

In the third embodiment, preferably, the vector of at least one hidden layer is calculated through forward propagation by using the neural network language model 20 and the training corpus 10.

In the third embodiment, the training unit 505 that trains the neural network auxiliary model by using the vector of at least one hidden layer and the normalization factor calculated by the calculating unit 501 as an input and an output respectively. Actually, the neural network auxiliary model can be considered as a function to fit the vector of at least one hidden layer and the normalization factor. There are various models which can be used as the auxiliary model to estimate the normalization factor. The more parameters the model has, the more accurate the estimation of the normalization is, and meanwhile it requires much higher computation cost. In practical application, according to the requirement, different sizes of models can be chosen to balance the accuracy and calculation speed.

In the third embodiment, preferably, the neural network auxiliary model is trained by using the vector of at least one hidden layer as the input and using a logarithm of the normalization factor as the output. In the third embodiment, in the case that the differences of the normalization factor in the train corpus are large, a logarithm of the normalization factor is used as the output.

In the third embodiment, preferably, the neural network auxiliary model is trained by decreasing an error between a prediction value and a real value of a normalization factor, wherein the real value is the calculated normalization factor. Moreover, preferably, the error is decreased by updating parameters of the neural network auxiliary model by using a gradient decent method. Moreover, preferably, the error is a root mean square error.

Next, an example will be described in details with reference to FIG. 2. FIG. 2 is a flowchart of an example of the process of training a neural network auxiliary model according to the first embodiment.

As shown in FIG. 2, the normalization factor Z is calculated by the neural network language model 20 by using the training corpus 10, the vector H of the last hidden layer 202ₙ is calculated through forward propagation, and the training data 30 is obtained.

Then, the neural network auxiliary model 40 is trained by using the vector H of the last hidden layer 202ₙ as the input of the neural network auxiliary model 40 and using the normalization factor Z as the output of the neural network auxiliary model 40. The training objective is to decrease a root mean square error between a prediction value and a real value which is the normalization factor Z. The root mean square error is decreased by updating parameters of the neural network auxiliary model by using a gradient decent method until the model is converged.

The apparatus 500 of training a neural network auxiliary model of the third embodiment uses an auxiliary model to fit the normalization factor and do not involve an extra parameter like the weight of the training objectives which must be tuned by practical experience compared to the traditional method which uses new training objective function. Therefore, the whole training is much more simple and easy to use, and the computation is decreased while the classification accuracy is not decreased.

<A Speech Recognition Apparatus>

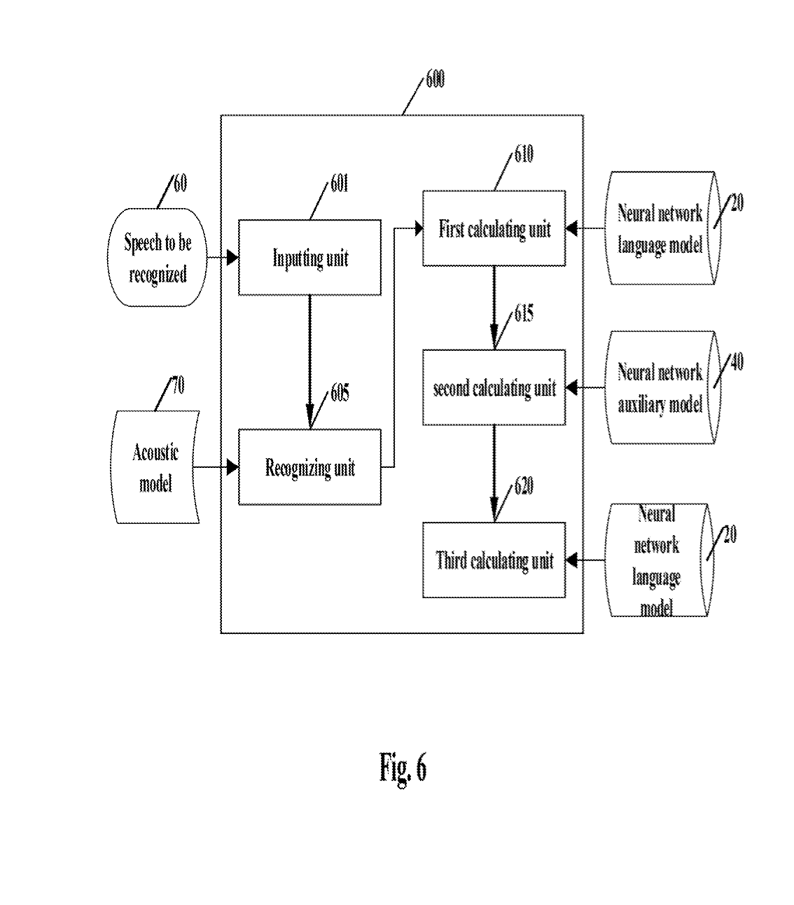

FIG. 6 is a block diagram of a speech recognition apparatus according to a fourth embodiment under a same inventive concept. Next, this embodiment will be described in conjunction with that figure. For those same parts as the above embodiments, the description of which will be properly omitted.

As shown in FIG. 6, the speech recognition apparatus 600 comprises: an inputting unit 601 that inputs a speech to be recognized 60; a recognizing unit 605 that recognizes the speech to be recognized 60 into a word sequence by using an acoustic model 70; a first calculating unit 610 that calculates a vector of at least one hidden layer by using a neural network language model 20 and the word sequence; a second calculating unit 615 that calculates a normalization factor by using the vector of the at least one hidden layer as an input of a neural network auxiliary model 40 trained by using the apparatus of the third embodiment; and a third calculating unit 620 that calculates a score of the word sequence by using the normalization factor and the neural network language model 20.

In the fourth embodiment, a speech to be recognized 60 is inputted by the inputting unit 601. The speech to be recognized 60 may be any speech and the embodiment has no limitation thereto.

In the fourth embodiment, the speech to be recognized 60 is recognized by the recognizing unit 605 into a word sequence by using the acoustic model 70.

In the fourth embodiment, the acoustic model 70 may be any acoustic model known in the art, which may be a neural network acoustic model or may be other type of acoustic model.

In the fourth embodiment, the method for recognizing a speech to be recognized 60 into a word sequence by using the acoustic model 70 is any method known in the art, which will not be described herein for brevity.

The first calculating unit 610 calculates a vector of at least one hidden layer by using a neural network language model 20 trained in advance and the word sequence recognized by the recognizing unit 605.

In the fourth embodiment, the vector of which layer or which layers is calculated is determined based on an input of a neural network auxiliary model 40 trained by using the method of the third embodiment. Preferably, the vector of the last hidden layer is used as the input when training the neural network auxiliary model 40, and, in this case, the vector of the last hidden layer is calculated by the first calculating unit 610.

The second calculating unit 615 calculates a normalization factor by using the vector of at least one hidden layer calculated by the first calculating unit 610 as the input of the neural network auxiliary model 40.

The third calculating unit 620 calculates a score of the word sequence by using the normalization factor calculated by the second calculating unit 615 and the neural network language model 20.

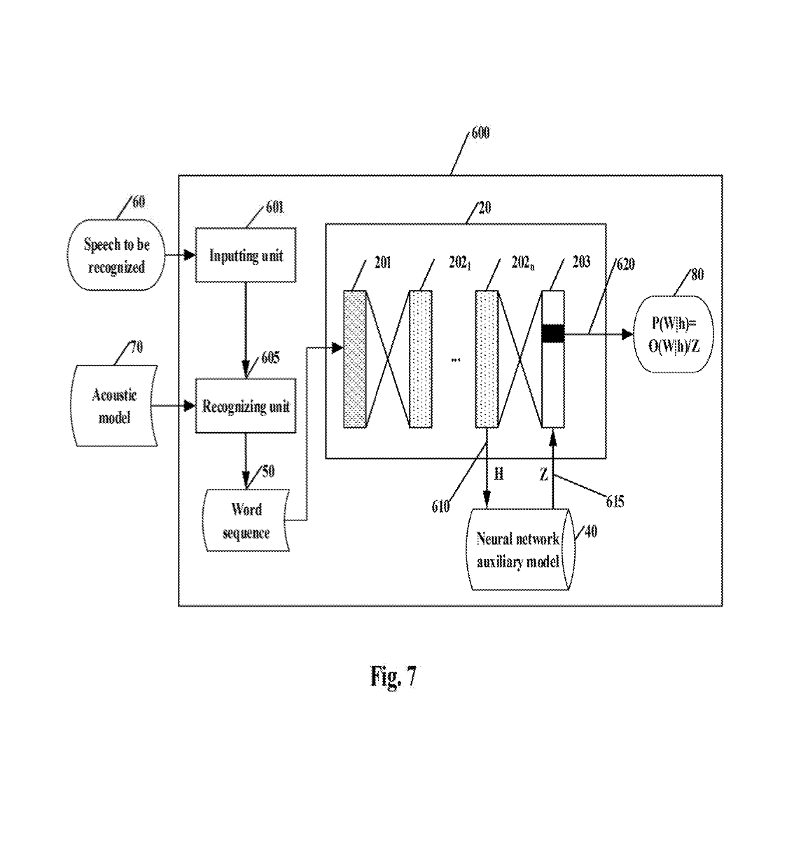

Next, an example will be described in details with reference to FIG. 7. FIG. 7 is a block diagram of an example of the speech recognition apparatus according to the fourth embodiment.

As shown in FIG. 7, the speech to be recognized 60 is recognized by the recognizing unit 605 into a word sequence 50 by using an acoustic model 70.

Then, the word sequence 50 is inputted into the neural network language model 20, and the vector H of the last hidden layer 202ₙ is calculated by the first calculating unit 610 through forward propagation.

Then, the vector H of the last hidden layer 202ₙ is inputted into the neural network auxiliary model 40, and the normalization factor Z is calculated by the second calculating unit 615.

Then, the normalization factor Z is inputted into the neural network language model 20, and the score of the word sequence 50 is calculated by the third calculating unit 620 by using the following formula based on the output “O(W|h)” 80 of the neural network language model 20.

P(W|h)=O(W|h)/Z

The first calculating unit 610 for calculating the vector of at least one hidden layer by using a neural network language model 20 and the third calculating unit 620 for calculating a score of the word sequence by using the neural network language model 20 are two calculating units, but the two calculating units can be realized by one calculating unit.

The speech recognition apparatus 600 of the fourth embodiment uses a neural network auxiliary model trained in advance to calculate the normalization factor of the neural network language model. Therefore, the computation speed of the neural network language model can be significantly increased, and the speech recognition method can be applied to the real-time speech recognition system.

Although a method for training a neural network auxiliary model, an apparatus for training a neural network auxiliary model, a speech recognition method and a speech recognition apparatus of the present invention have been described in detail through some exemplary embodiments, the above embodiments are not to be exhaustive, and various variations and modifications may be made by those skilled in the art within spirit and scope of the present invention. Therefore, the present invention is not limited to these embodiments, and the scope of which is only defined in the accompany claims.

1. An apparatus for training a neural network auxiliary model which is used to calculate a normalization factor of a neural network language model different from the neural network auxiliary model, comprising:
a calculating unit that calculates a vector of at least one hidden layer and a normalization factor of the neural network language model by using the neural network language model and a training corpus; and
a training unit that trains the neural network auxiliary model by using the vector of the at least one hidden layer and the normalization factor as an input and an output of the neural network auxiliary model respectively.

2. The apparatus according to claim 1, wherein the calculating unit calculates the vector of the at least one hidden layer through forward propagation by using the neural network language model and the training corpus.

3. The apparatus according to claim 2, wherein the at least one hidden layer is a final hidden layer in the neural network language model.

4. The apparatus according to claim 1, wherein the training unit trains the neural network auxiliary model by using the vector of the at least one hidden layer as the input and using a logarithm of the normalization factor as the output.

5. The apparatus according to claim 1, wherein
the training unit trains the neural network auxiliary model by decreasing an error between a prediction value and a real value of the normalization factor, and
the real value is the calculated normalization factor.

6. The apparatus according to claim 5, wherein the training unit decreases the error by updating parameters of the neural network auxiliary model by using a gradient decent method.

7. The apparatus according to claim 5, wherein the error is a root mean square error.

8. A speech recognition apparatus, comprising:
an inputting unit that inputs a speech to be recognized;
a recognizing unit that recognizes the speech into a word sequence by using an acoustic model;
a first calculating unit that calculates a vector of at least one hidden layer by using a neural network language model and the word sequence;
a second calculating unit that calculates a normalization factor by using the vector of the at least one hidden layer as an input of a neural network auxiliary model trained by using the apparatus according to claim 1; and
a third calculating unit that calculates a score of the word sequence by using the normalization factor and the neural network language model.

9. A method for training a neural network auxiliary model which is used to calculate a normalization factor of a neural network language model different from the neural network auxiliary model, comprising:
calculating a vector of at least one hidden layer and a normalization factor of the neural network language model by using the neural network language model and a training corpus; and
training the neural network auxiliary model by using the vector of the at least one hidden layer and the normalization factor as an input and an output of the neural network auxiliary model respectively.

10. A speech recognition method, comprising:
inputting a speech to be recognized;
recognizing the speech into a word sequence by using an acoustic model;
calculating a vector of at least one hidden layer by using a neural network language model and the word sequence;
calculating a normalization factor by using the vector of the at least one hidden layer as an input of a neural network auxiliary model trained by using the method according to claim 9; and
calculating a score of the word sequence by using the normalization factor and the neural network language model.
